(19) United States
(12) Patent Application Publication
(10) Pub. No.: US 2011/0303703 A1
(43) Pub. Date: Dec. 15, 2011

(54) APPARATUS FOR DISPENSING A CONTROLLED DOSE

(76) Inventors: Don F. Yeager, Millville, NJ (US); Paul H. Andrews, Millville, NJ (US); Michael K. Carter, Horsham, PA (US); Jerome P. Rosenthal, Philadelphia, PA (US); David J.G. Jones, Collegeville, PA (US); Kevin R. Clover, Doylestown, PA (US)

(21) Appl. No.: 12/911,271

(22) Filed: Oct. 25, 2010

Related U.S. Application Data
(60) Provisional application No. 61/255,791, filed on Oct. 28, 2009.
(60) Provisional application No. 61/348,394, filed on May 26, 2010.

(51) Int. Cl. G01F 11/00

(52) U.S. Cl. 222/386; 222/541.9

(57) ABSTRACT

An apparatus for dispensing a controlled dose of a substance wherein the apparatus includes a compressible tube portion, a tip portion extending from the tube portion sized to receive a substance to be dosed, and a breakaway portion being removably coupled to the tip portion. The breakaway portion reveals an aperture in the tip portion upon removal of the breakaway portion. Finally, a valve member is slidably disposed in the tip portion such that the valve member can be movable in response to fluid pressure and/or manual force application to urge the substance within the tip portion out of the aperture as a controlled dose.

### CROSS-REFERENCE TO RELATED APPLICATIONS

This application claims the benefit of U.S. Provisional Application No. 61/255,791, filed on Oct. 28, 2009 and U.S. Provisional Application No. 61/348,394, filed on May 26, 2010. The entire disclosures of each of the above applications are incorporated herein by reference.

### FIELD

The present disclosure relates to dispensers and, more particularly, relates to an apparatus for dispensing a controlled dose.

### BACKGROUND

This section provides background information related to the present disclosure which is not necessarily prior art.

Dispensers for dispensing liquids, gels and the like are known in that art. Some of these conventional dispensers include a dispensing mechanism that is designed to dispense a particular amount of liquid, gel, etc. upon a single activation of the dispensing mechanism. In some circumstances, the amount of liquid, gel, and the like to be dispensed should be controlled and accurate.

### SUMMARY

This section provides a general summary of the disclosure, and is not a comprehensive disclosure of its full scope or all of its features.

The present disclosure generally relates to new and novel structures for dispensing a controlled dose. More particularly, the disclosure provides an apparatus for dispensing a controlled dose of a substance wherein the apparatus includes a compressible tube portion, a tip portion extending from the tube portion sized to receive a substance to be dosed, and a breakaway portion being removably coupled to the tip portion. The breakaway portion reveals an aperture in the tip portion upon removal of the breakaway portion. Finally, a valve member is slidably disposed in the tip portion such that the valve member can be movable in response to fluid pressure and/or manual force application to urge the substance within the tip portion out of the aperture as a controlled dose.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an apparatus for dispensing a controlled dose according to at least one aspect of the disclosure;

FIG. 2 illustrates a tube of an apparatus for dispensing a controlled dose according to at least one aspect of the disclosure;

FIGS. 3A and 3B illustrate various features of a tube of an apparatus for dispensing a controlled dose according to at least one aspect of the disclosure;

FIGS. 4A, 4B and 4C illustrate various features of a check valve of an apparatus for dispensing a controlled dose according to at least one aspect of the disclosure;

FIGS. 4D and 4E illustrate various features of a check valve of an apparatus for dispensing a controlled dose according to at least one aspect of the disclosure;

FIG. 4F illustrates the apparatus for dispensing a controlled dose shown in FIG. 4D in an uncompressed state according to at least one aspect of the disclosure;

FIG. 4G illustrates the apparatus for dispensing a controlled dose shown in FIG. 4D in a compressed state according to at least one aspect of the disclosure;

FIG. 4H illustrates various features of a check valve of an apparatus for dispensing a controlled dose according to at least one aspect of the disclosure;

FIG. 4I illustrates various features of a check valve of an apparatus for dispensing a controlled dose according to at least one aspect of the disclosure;

FIG. 5 illustrates an apparatus for dispensing a controlled dose according to at least one aspect of the disclosure;

FIG. 6 illustrates an embodiment of retaining device of an apparatus for dispensing a controlled dose according to at least one aspect of the disclosure;

FIG. 7 illustrates an apparatus for dispensing a controlled dose of at least two different substances according to at least one aspect of the disclosure; and

FIG. 8 illustrates an apparatus for dispensing multiple controlled doses according to at least one aspect of the disclosure.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Initially, it is noted that, for the sake of brevity, throughout the disclosure the terms “fluid” and “substance” may be used interchangeably to refer to any substances that may be used in a dispensing apparatus according to aspects of this disclosure. Such substances may include, but are not limited to: liquids, gels, lotions, creams, salves, and the like.

As discussed above, some circumstances may require dispensers to reliably dispense an accurate amount of a substance (i.e., a controlled dose). This may be especially true, when the controlled dose to be dispensed is a relatively small amount (e.g., in the range 0.2-0.6 milliliters). For example, in some cases, as much as 30% to 50% of the desired controlled dose that is desired to be dispensed may remain in the dispenser. Therefore, aspects of the disclosure are directed to dispensers which accurately dispense the desired amount of a substance, even if the controlled dose is relatively small (e.g., in the range 0.2-0.6 milliliters).

It is noted that the dispensing of such small amounts of substance is particularly common in the fields of science and medicine wherein small amounts of substances may be used to various purposes (e.g., to treat various maladies). Further, it is noted that in such an environment, the controlled dose may be extremely relevant to the treatment. Hence, it would be desirable to ensure that controlled dose is dispensed accurately and reliably. Therefore, a dispenser according to aspects of disclosure may have particular usefulness in such fields. For example, aspects of the disclosure may relate to a dispenser configured for dispensing an accurate and controlled dose of a substance (e.g., a medicine or other chemical) in a nasal passageway.

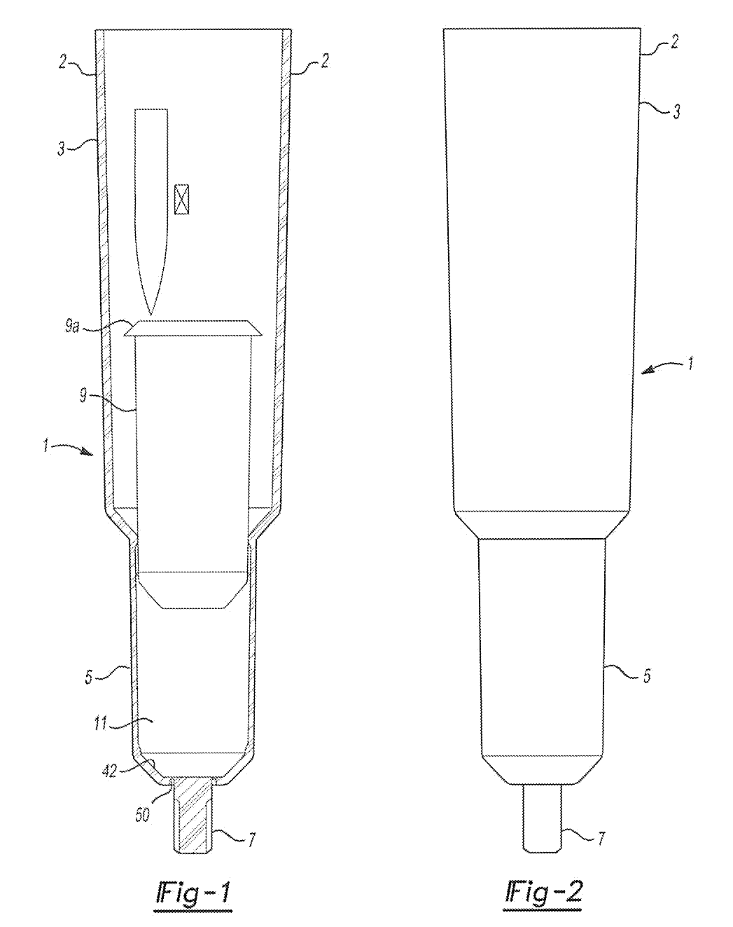

An illustrative embodiment of an apparatus for dispensing an accurate and controlled dose according to one aspect of the disclosure is shown at FIG. 1. As shown in FIG. 1, the dispensing apparatus 1 includes a tube 2 with a compressible section 3, a tip 5, and a breakaway section 7. As shown in FIG. 1, the dispensing apparatus 1 may also include a check valve 9.

According to aspects of the disclosure, the compressible section 3 of the tube 2 may be at atmospheric pressure (i.e., the compressible section of the tube 2 may be filled with air). Further, the tip 5 of the tube 2 may be filled with a particular amount of fluid or other substance 11. According to some aspects of the disclosure, the tip 5 is not completely filled with the fluid or other substance 11. For example, as shown in FIG. 1, the tip 5 is only partially filled with the fluid or other substance 11. According to some aspects of the disclosure, the amount of fluid or other substance 11 in the tip is approximately equal to the desired amount of fluid or other substance 11 to be dispensed (i.e., the accurate and controlled dose). Although, it is noted that according to other aspects of the disclosure, the amount of fluid or other substance 11 in the tip 5 may be slightly more than the accurate and controlled dose (e.g., 1-10% more). As seen in FIG. 1, amount of fluid or other substance 11 in the tip 5 may be in the range of 0.2 fluid milliliters. According to aspects of the disclosure, the check valve 9 is inserted into the tube 2 and, as seen in FIG. 1, one end of the check valve 9 may be inserted into the tip 5.

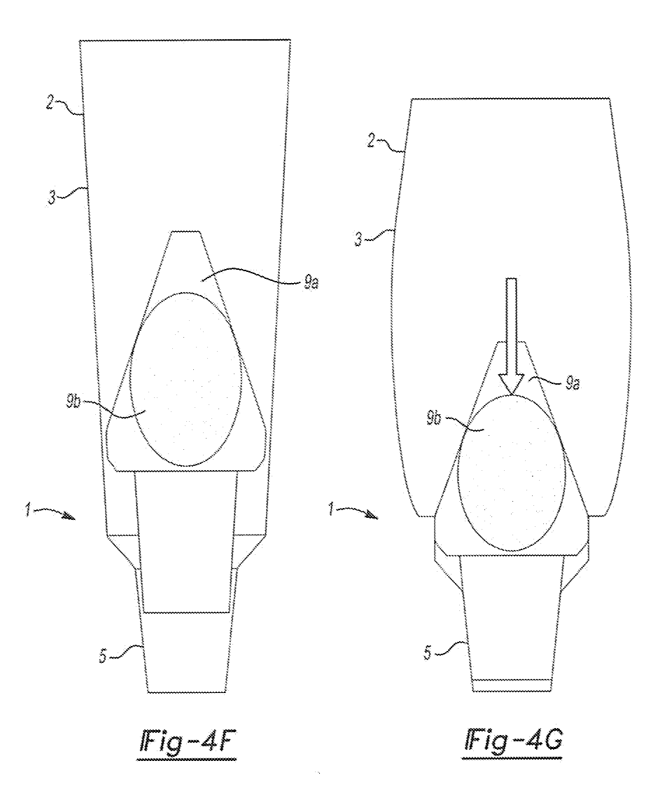

The operation of the dispensing apparatus 1 is described below. Initially, the user may break off the breakaway section 7. This breakaway section 7 is primarily useful for holding the fluid or other substance 11 in the tip of the dispensing apparatus 1 until the fluid or other substance 11 is to be dispensed. Additionally, the breakaway section 7 may be useful in preventing contamination of the fluid or other substance 11. In some embodiments, as illustrated in FIGS. 1 and 5, breakaway section 7 can comprise a generally cylindrical or other convenient shape (e.g. winged shape, splined shape, flanged shape, and the like) having a reduced material annular section 50. Annular section 50 can be adapted to encourage breaking of breakaway section 7 along a predetermined pathway. Therefore, annular section 50 can be sized to define a predetermined or preferred diameter and/or shape of the resultant aperture through which substance 11 will exit.

When breakaway section 7 is broken off of the dispensing apparatus 1, an orifice or aperture is created at the end of the tip 5 through which the fluid or other substance 11 may be dispensed. Therefore, once a user breaks off the break away section 7, the user may compress the compressible section 3 of the tube 2 (e.g., the user may squeeze the compressible section 3). When the compressible section 3 is compressed, the air in the compressible section pushes the check valve 9 down the tube 2 so that the check valve 9 is pushed further into the tip 5 of the tube 2. Alternatively, or in addition to the air in the compressible section 3 pushing the check valve 9 down the tube 2, according to some aspects of the disclosure, the check valve 9 may be configured such that the user may compress the compressible section 3 of the tube 2 in order to manually contact the check valve 9 (e.g., the user's fingers may indirectly contact the check valve 9 via the compressible section 3) and thereby, the user may manually push the check valve 9 down the tube 2 and into the tip 5 of the tube 2. Thereby, the check valve 9 forces the fluid or other substance 11 (i.e., the accurate and controlled dose) to be dispensed through an opening in the tip 5 and, hence, out of the dispensing apparatus 1. Therefore, it is understood that, according to various embodiments of the disclosure, the user may compress the compressible section 3 in order to: cause air in the compressible section to push the check valve 9 down the tube 2; manually push the check valve 9 down the tube 2; or use a combination of the air and manual power to push the check valve down the tube 2. According to aspects of this disclosure, upon compression of the compressible section 3, the check valve 9 is moved into the tip 5 so that it virtually fills the tip 5 and thereby dispenses the entire accurate and controlled dose.

Given the general description of various example aspects of the disclosure provided above, more detailed descriptions of various specific example features of dispensing apparatus structures according to the disclosure are provided below.

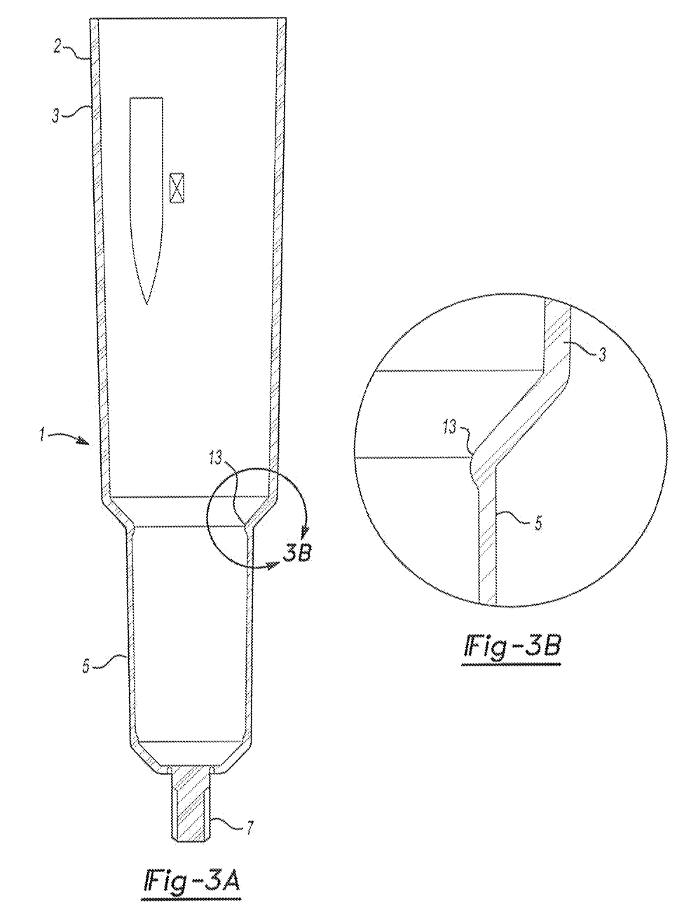

According to some aspects of this disclosure, the overall length of the dispensing apparatus may be in the range of 2 inches or less. For example, as shown in FIG. 2, the length of the illustrative embodiment is approximately 1.9 inches. Further, as shown in FIG. 2, according to some embodiments of this disclosure, the compressible section 3 may have a larger diameter or cross-section than the diameter or cross section of the tip 5. Further, the diameter or cross section of the tip 5 may be larger than the diameter or cross section of the breakaway section 7. Additionally, the wall of the compressible section 3 may be tapered from a first end, which is farthest from the breakaway section 7, towards a second end, which is adjacent the tip 5 so that the compressible section 3 narrows as it approaches the tip 5. Also, the walls of the tip 5 may be tapered from a first end, which is farthest from the breakaway section 7, towards a second end, which is adjacent the breakaway section 7 so that the tip 5 narrows as it approaches the breakaway section 7. According to particular aspects of this disclosure, the amount of taper in the tip 5 may be approximately 0.5°, 1.0° or the like.

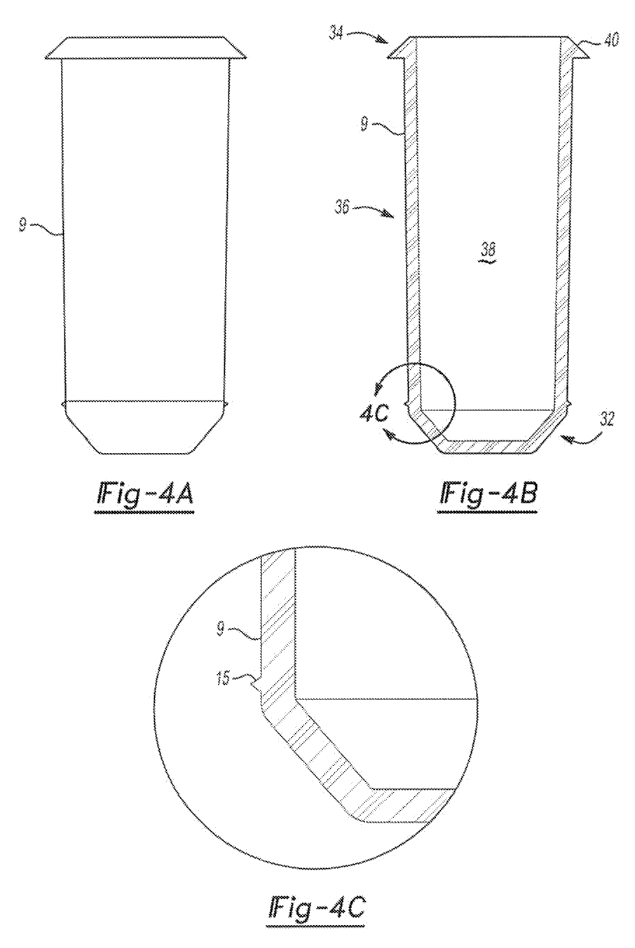

According to particular embodiments of this disclosure, the tube 2 may include a retaining device. In the illustrative embodiment, the retaining device may be in the form of a retaining ring 13. This is most clearly seen in FIGS. 3A and 3B. As shown in FIG. 3A, according to some aspects of the disclosure, the retaining ring 13 may be positioned at an area of the tube 2 where in compressible section 3 and the tip 5 meet. As shown in FIG. 3B, the retaining ring 13 projects inwardly from the interior of the wall of the tube 2. According to aspects of the disclosure, the retaining ring 13 may project 4/1000 of an inch. The retaining ring 13 provides an interference fit between the tube 2 and the check valve 9. Thereby, the retaining ring 13 prevents the check valve 9 from disengaging with the tip 5 and sliding back into the compressible section 3. Hence, the structure of the tube 2 (including the retaining ring 13) and structure of the check valve 9 ensure that the fluid or other substance 11 contained in the tip 5 does not leak, seep or otherwise escape from the tip 5. Therefore, an accurate and controlled dose in the tip 5 is maintained.

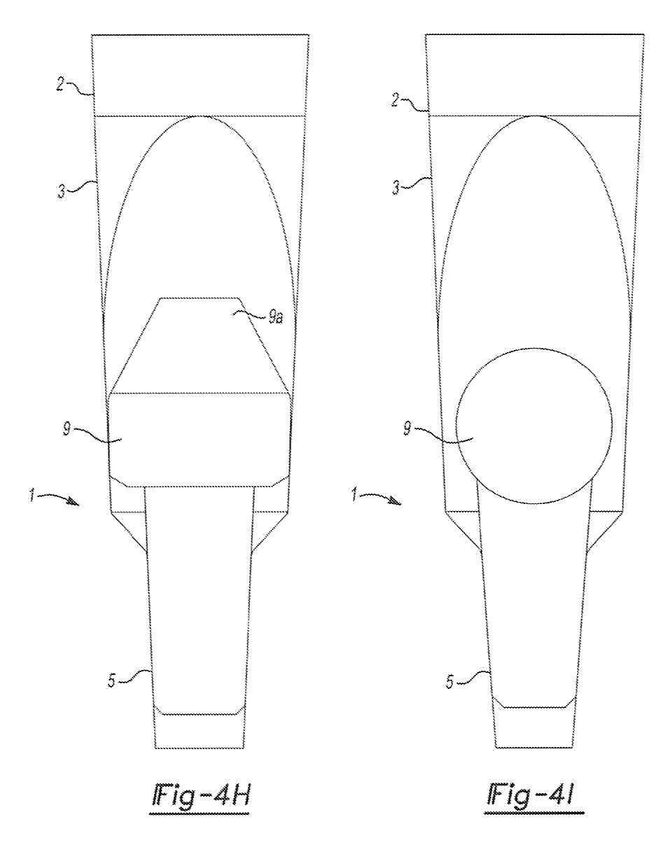

It is noted that while the illustrative embodiment discloses a retaining ring 13, according to other embodiments the retaining device may be one or more projections that project inwardly from the interior of the wall of the tube 2. For example, the retaining device could comprise a series of separate projections 20 positioned equidistantly around the inner circumference of the tube 2 where the compressible section 3 meets the tip 5. An example of such separate projections 20 is shown in FIG. 6.

The check valve 9 has several functions. For example, as described above, the check valve 9 can prevent the fluid or other substance 11 contained in the tip 5 from escaping from the tip 5. Also, the check valve 9 can ensure that the proper dose is dispensed from the dispensing apparatus 1. For example, as described above, upon compression of the compressible section 3, the check valve 9 is pushed into the tip 5 and thereby dispenses the controlled dose through the orifice or opening in the tip 5 once the breakaway section 7 has been removed. For example, according to some embodiments of the disclosure, the user may compress the compressible section 3 of the tube 2 to use the air in the compressible section 3 to push the check valve 9 down the tube 2. Further, according to other embodiments of the disclosure, the user may compress the compressible section 3 of the tube 2 to contact the check valve 9 and manually push the check valve 9 down the tube 2 (e.g., the user could apply a force at the angled portion 9a of the rear of the check valve 9 shown in FIG. 1).

Further, as mentioned above, the walls of the tube 2 that comprise the tip 5 may be tapered (e.g., tapered by 0.5° or 1.0°). Therefore, the fit between the tip 5 and the check valve 9 may become tighter as the check valve 9 continues down the tip 5. This feature of the structure of the tip 5 of the dispensing apparatus 1 aids in ensuring that at least most and, in some cases, virtually all of the fluid or other substance 11 contained in the tip 5 is dispensed through the opening in the tip 5 once the breakaway section 7 has been removed.

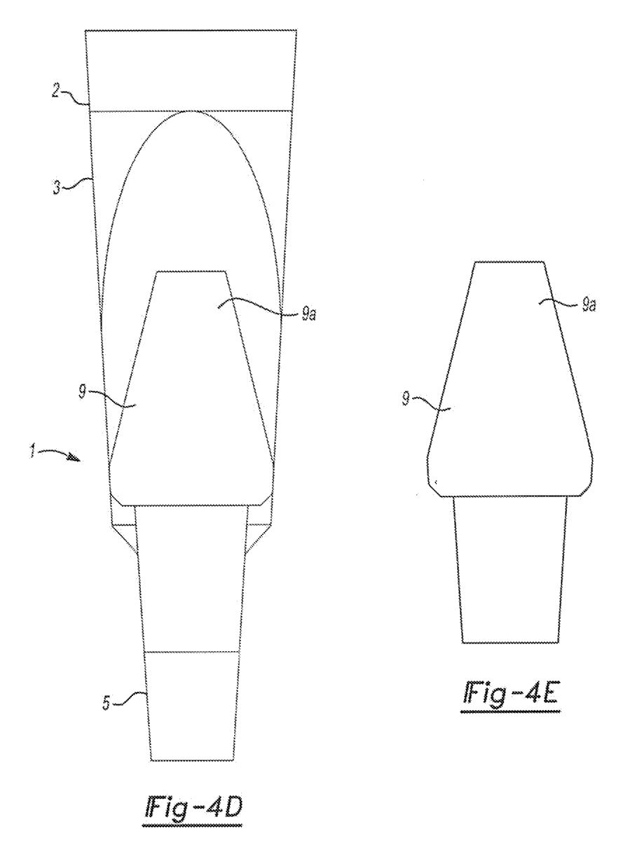

As seen in FIG. 1, according to some embodiments the check valve 9 may be a piston. FIGS. 4A-4I shows various features of a piston according to aspects of this disclosure. For example, FIG. 4A shows an embodiment of a piston according to aspects of this disclosure. Generally, valve member or check valve 9 can define an elongated cylindrical shape having a distal end 32, a proximal end 34, and interconnecting section 36. In some embodiments, check valve 9 can be hollow, thereby defining an interior volume 38. Proximal end 34 can comprise a circumferential flange 40 that can, in some embodiments, provide slidable support of check valve 9 within tip 5. Distal end 32 can comprise a tapered shape to encourage non-binding movement of check valve 9 within tip 5. In some embodiments, distal end 32 is shaped to cooperate with a distal surface 42 (FIG. 1) of tip 5 to minimize substance 11 remaining in tip 5 after sliding movement of check valve 9.

As seen in FIG. 4B, according to some embodiments of this disclosure the piston may be in the range of 0.58 to 0.6 inches in length. However, it is noted that according to other aspects of the disclosure, the piston may be larger or smaller as desired. For example, the size of the piston may vary based on the size of the tube 2 (e.g., vary based on whether the tube is a two ml tube, a three ml tube, etc.). Also, as seen in FIGS. 4B and 4C, the piston may include a wiper ring 15. As seen, the wiper ring 15 may be positioned at an end of the piston that is near the breakaway section 7 of the tube 2. The wiper ring 15 may extend from the outer side of the wall of the piston and form a continuous ring around the outer side of the wall of the piston. The wiper ring 15 may be formed of a flexible material that engages with the inner wall of the tip 5. Hence, when the piston is pushed down into the tip 5 to dispense the fluid or other substance 11 from the dispensing apparatus 1, the wiper ring 15 may act as a squeegee to ensure no portion of the fluid or other substance 11 escapes past the piston as it moves through the tip 5. Thereby, the dispensing apparatus 1 can virtually ensure that most, if not all, of the fluid or other substance 11 in the tip 5 is dispensed from the dispensing apparatus 1. The wiper ring 15 is shown in greater detail in FIG. 4C. As seen, the wiper ring 15 may be relatively small, such as in the range of 0.007 inches in height. According to some aspects of this disclosure, an o-ring or a rubber overmold can be used in place of the wiper ring 15. According to such an embodiment of this disclosure which employs an o-ring or overmold, the o-ring or overmold will have the same function described above of acting to prevent or minimize fluid or other substance 11 moving past the piston as it moves through the tip 5. It is noted that while the embodiment shown in FIGS. 4A-4C includes a single wiper ring 15, of course, multiple wiper rings may be used if desired.

Aspects of the disclosure relate to various embodiments of the check valve 9. For example, the check valve 9 may have various shapes and sizes. While the illustrative embodiment described above in FIGS. 4A-4C discloses an example of a check valve 9 according to some aspects of the disclosure, many other embodiments of check valves 9 are contemplated and considered within the scope of the disclosure. For example, according aspects of the disclosure, various embodiments of a check valve 9 may have a configuration which further aids a user in contacting the check valve 9 and manually pushing the check valve 9 down the tube 2 when the user compresses the compressible section 3 of the tube 2. For example, the check valve 9 may include angled shape. FIG. 4D illustrates such an embodiment of a check valve 9 according to aspects of the disclosure.

As seen in FIG. 4D, the illustrative check valve 9 includes a rear portion 9a (it is noted that solely for reference purposes the term “rear portion” in this context refers to the portion of the check valve 9 that is farther away from the tip 5 than closer to the tip 5) which tapers in a direction from the tip 5 to the rear of the tube 2. This angled rear portion 9a of the check valve 9 may aid the user in positioning his or her fingers on the check valve 9 and manually pushing the check valve 9 down the tube 2 when the user compresses the compressible section 3 of the tube 2. For example, the user may grasp the dispensing apparatus 1 and compress the compressible section 3 between the user's thumb and forefinger. The compression applied by the user's thumb and forefinger will provide a force on the rear of the rear portion 9a of the check valve 9 and the user will be able to slide the check valve 9 down the tube 2. Thereby, the check valve 9 forces the fluid or other substance 11 (i.e., the accurate and controlled dose) to be dispensed through an opening in the tip 5 and, hence, out of the dispensing apparatus 1.

By configuring the rear portion of the check valve 9 with angled sides (or configuring the rear portion of the check valve 9 such that it is angled all the way around the circumference (e.g., providing a conical-like shape)) it may be relatively easier for the user to position and align their fingers on the check valve 9 in order to push the check valve 9 down the tube 2. Further, by configuring the check valve 9 in such a fashion, the user may inherently realize if their fingers are positioned “correctly” in order to more easily push the check valve 9 down that tube 2 when the user compresses the compressible section 3 of the tube 2 and, also, may adjust their fingers accordingly if needed.

According to aspects of the disclosure, the length of the check valve 9 may be in a range of 1.0-1.2 inches (e.g., approximately 1.158 inches), the length of the rear angled portion 9a of the check valve 9 may be in a range of 0.5-0.6 inches (e.g., approximately 0.542 inches) and the length of the tip of the check valve 9 may be in a range of 0.5-0.7 inches (e.g., approximately 0.616 inches). According to aspects of the disclosure, the width of the top of the check valve 9 may be in a range of 0.05-0.07 inches (e.g., approximately 0.063 inches), the width of the bottom of the rear angled portion 9a of the check valve 9 may be in a range of 0.4-0.5 inches (e.g., approximately 0.421 inches), and the width of the bottom of the check valve 9 (e.g., the end of the check valve nearest the tip 5) may be in a range of 0.2-0.3 inches (e.g., approximately 0.208 inches).

Further, according to aspects of the disclosure, the angled rear portion 9a of the check valve 9 may be configured to receive a typical finger and thumb. In other words, the angled rear portion of the check valve 9 may include concave surfaces 9b (see FIGS. 4F and 4G) that would mate with the convex shape of the user's fingers. This may further aid the user in aligning his or her fingers and, also, pushing the check valve 9 down the tube 2 when the user compresses the compressible section 3 of the tube 2. Of course, other configurations that may increase traction between the check valve 9 and the user's fingers (e.g., ridges on the angled rear portion 9a of the check valve 9) or may aid the user in realizing a “proper” positioning of their fingers (e.g., a positioning that makes it relatively easy to slide the check valve 9 down the tube 2) may be used as well.

According to aspects of the disclosure, in embodiments wherein the user may contact the check valve 9 and manually push the check valve 9 down the tube 2 when the user compresses the compressible section 3 of the tube 2, the length of the check valve 9 may be sufficiently long to provide the user's fingers with sufficient space to contact the check valve 9 in order manually push the check valve 9 down the tube 2 when the user compresses the compressible section 3 of the tube 2. For example, as seen in FIG. 1, the user may apply pressure to the angled portion 9a of the rear of the piston. By way of another example, in FIG. 4D the angled portion 9a of the rear of the piston may be longer than the embodiment shown in FIG. 1. For example, as seen in FIG. 4E, the illustrative check valve 9 shown in FIG. 4D may include a length in the range of 1.0-1.2 inches and the angled portion 9a of the rear portion may be in a range of 0.5-0.6 inches. However, the length may vary as desired (e.g., the length may vary based on the size of the tube 2).

FIG. 4F shows another embodiment of the check valve 9 within the tube 2 according to aspects of the disclosure. The embodiment of the check valve 9 shown in FIG. 4F is similar to the embodiments discussed above and, therefore, for the sake of brevity, will not be elaborated on in great detail here. However, it is noted that, as seen in FIG. 4F, the illustrative check valve 9 may have a shorter angled portion 9a of the rear portion of the check valve 9 as compared with the check valve shown in FIG. 4D. Further, the portion of the rear portion of the check valve that is not angled (e.g., the portion closer to the tip of the piston) may be longer as compared with the corresponding portion of the illustrative embodiment of the check valve 9 shown in FIG. 4D. Hence, as demonstrated by a comparison of such embodiments, it is understood that the shape and size of the check valve 9 may vary as desired. Further, as discussed above with regard to the illustrative embodiments shown in FIGS. 4A-E, a configuration of the check valve 9 such as shown in FIG. 4F may aid the user in contacting the check valve 9 and manually pushing the check valve 9 down the tube 2 when the user compresses the compressible section 3 of the tube 2 and also in determining if his or her fingers are positioned “correctly” in order to more easily push the check valve 9 down that tube 2 when the user compresses the compressible section 3 of the tube 2.

FIG. 4G shows another embodiment of the check valve 9 within the tube 2 according to aspects of the disclosure. The embodiment of the check valve 9 shown in FIG. 4G is similar to the embodiments discussed above and, therefore, for the sake of brevity, will not be elaborated on in great detail here. However, it is noted that, as seen in FIG. 4G, the illustrative check valve 9 may be in the shape of a ball or otherwise spherical. As discussed above with regard to the illustrative embodiments shown in FIG. 4A-F, a configuration of the check valve 9 such as shown in FIG. 4G may aid the user in contacting the check valve 9 and manually pushing the check valve 9 down the tube 2 when the user compresses the compressible section 3 of the tube 2 and also in determining if his or her fingers are positioned “correctly” in order to more easily push the check valve 9 down that tube 2 when the user compresses the compressible section 3 of the tube 2.

According to some embodiments of the disclosure the check valve 9 may be a ball. For example, according to some aspects of the disclosure, the check valve 9 may be a solid, polypropylene ball with a diameter in the range of 0.24 inches and a smooth finish. FIG. 5 shows an embodiment of a dispensing apparatus 1 wherein a ball is used as the check valve 9. The ball check valve provides the above described functions of the check valve 9 (e.g., ensuring the fluid or other substance 11 does not retreat into the compressible section 3; pushing the fluid or other substance out the hole in the tip 5 after the breakaway section 7 of the dispensing apparatus 1 has been removed; etc.) in the same manner as described above.

According to some aspects of this disclosure, the tube 2 may be made of a plastic material such as polypropylene, high density polyethylene, low density polyethylene, polyethylene terephthalate (PET) or some other type of plastic. For example, the compressible section 3, the tip 5 and the breakaway section 7 may all be made from polypropylene. Additionally, other structures in the dispensing apparatus 1, such as the retaining ring 13, check valve 9 (either the piston or the ball), the wiper ring 15, may be made from a plastic material such as polypropylene, high density polyethylene, low density polyethylene, polyethylene terephthalate (PET) or some other type of plastic. According to some embodiments of this disclosure, the entire tube 2 is made from a single material and the wall thicknesses of the different sections (e.g., the compressible section 3, the tip 5, the breakaway section 7) are varied in order to provide appropriate rigidity. For example, according to one embodiment the tube is made of polypropylene and the wall thickness of tip 5 may be approximately twice the wall thickness of the compressible section 3. In this way, the tip is more rigid than the compressible section. A more rigid tip may be desirable as it will prevent buckling. However, this is merely one embodiment. Of course, according to different embodiments, different portions of the dispensing apparatus may be of different materials, have different thicknesses, different rigidities, etc. For example, the tip 5 and the breakaway section 7 may be made from different materials that are more rigid than the compressible section 3.

According to aspects of this disclosure, the dispensing apparatus 1 may be created by forming the tube 2 out of polypropylene, high density polyethylene, low density polyethylene, or some other type of plastic. This may be done via conventional processes such as molding, etc. Further, the controlled dose of fluid or other substance 11 may then be placed into the tip 5 of the tube 2. Once the controlled dose is in the tip 5, the check valve 9 may be inserted into position in the tube 2. For example a tamping rod may tamp the check valve 9 into the tube so that it is pushed beyond the retaining ring 13 in the direction of the breakaway section 7 and thereby extends into the tip 5. Additionally, once the check valve 9 is positioned within the tube 2, the tube 2 may be sealed. For example, the end of the compressible section 3 may be heat sealed via a crimping means. The above described process for forming the dispensing apparatus 1 is merely an example of one such process by which the dispensing apparatus may be formed and, of course, different variations of the process or other processes may be used.

While not shown in the drawings, according to some aspects of this disclosure, a cap may be used to cover the breakaway section 7 of the dispensing apparatus 1. This cap may prevent the breakaway section from being broken off accidently. The cap may extend over the breakaway section 7 and in some cases the cap may extend over some, or all, of the tip 5.

According to aspects of this disclose, the dispensing apparatus 1 may include an indicator which indicates to the user that the controlled dose has been dispensed. For example, the indicator could be visual, audible, sensory (e.g., felt through touch), etc. According to some aspects of the disclosure, the visual indicator could include the check valve 9 being made from a different color than the tube 2. In such an embodiment, the check valve 9 may be black and the tube 2 may be white or transparent. Therefore, the check valve 9 would be visible through the tube 2. Additionally, the outer surface of the tube 2 may contain indicators (e.g., lines) which show where the check valve 9 would be positioned when the dispensing apparatus 1 is full and when the dispensing apparatus 1 is empty (of course, other positions could be shown as well). Hence, the user could see when the check valve 9 was in the empty position and, therefore, understand that the controlled dose had been dispensed.

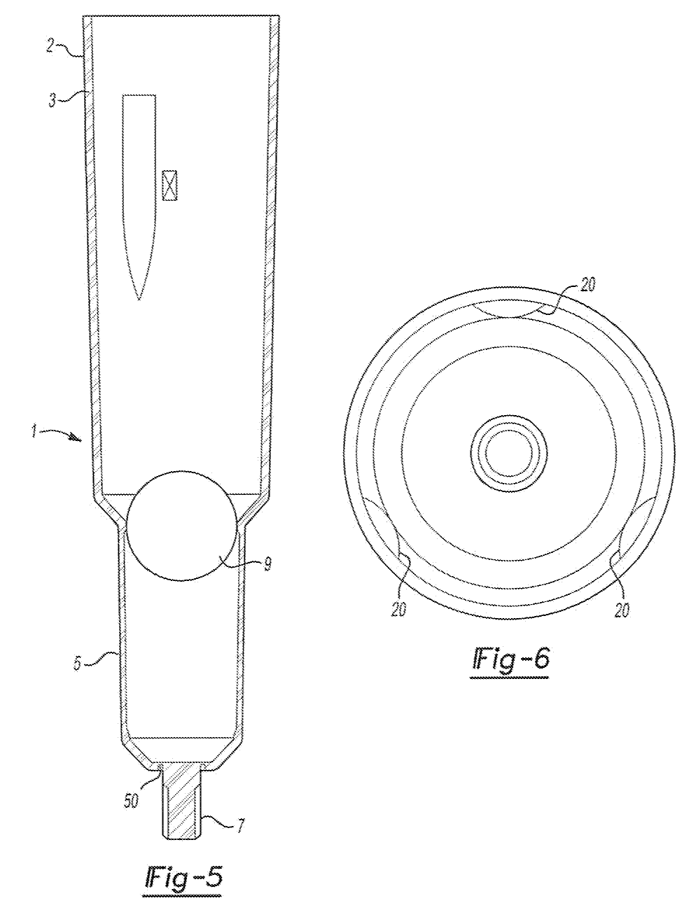

According to some aspects of this disclosure, the dispensing apparatus 1 may be configured to dispense a controlled dose of two different types of fluids or other substances 11. For example, in some circumstances, two different substances should not be mixed until they are dispensed. FIG. 7 illustrates such an apparatus for dispensing a controlled dose of at least two different substances according to at least one aspect of the disclosure. According to particular embodiments of this disclosure, the dispensing apparatus 1 may have a separating wall 26 in the tip 5 of the tube 2 that partitions the tip 5 into two sides—that is, defining two or more fluidly-distinct volumes within tip 5. Each partitioned side of the tip 5 would hold a different substance. The separating wall 26 may extend at least a majority the length of the tip 5 to ensure that the different substances were completely separated from each other and unable to be mixed while in the tip. Further, the dispensing apparatus 1 may include a breakable barrier in the tip 5 that prevents the two different types of fluids or other substances from mixing. The breakable barrier would be broken upon the check valve 9 being pushed into the tip 5 in order for the two different types of fluids or other substances to be dispensed. The check valve 9 would include a split piston (i.e. bifurcated) wherein one side of the piston would extend into the first partitioned side and the other side of the piston would extend into the second partitioned side. The piston may be configured so that both sides of the piston move at the same time and, hence, the two different substances are dispensed from the hole in the tip 5 at the same time. In this way, the two substances would be mixed upon being dispensed. Of course, this embodiment is not limited to two substances, as three or more substances could be implemented as desired with the respective structures in the partitioned tip and piston.

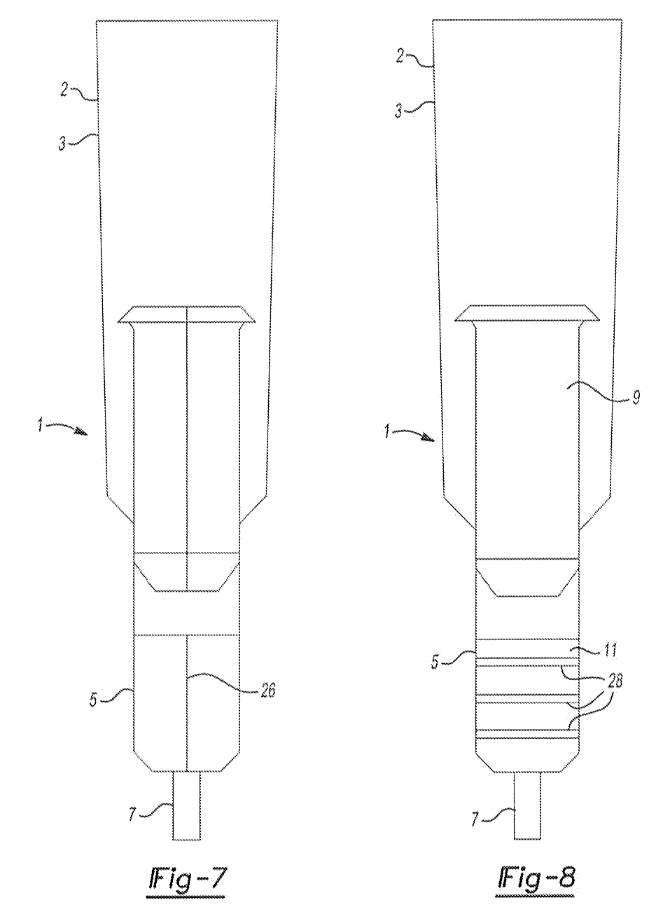

According to some aspects of this disclosure, the dispensing apparatus 1 may be configured to dispense multiple controlled doses. FIG. 8 illustrates an apparatus for dispensing multiple controlled doses according to at least one aspect of the disclosure. According to some embodiments of such aspects of the disclosure, the tip 5 of the dispensing apparatus 1 may include a series of dosage stops 28 which may be in the form of rings (e.g., similar to the retaining ring in size), protrusions or other retaining devices that are spaced from each other in a vertical fashion. The series of dosage stops 28 may be spaced accordingly such that space between the dosage stops 28 corresponds to amount of fluid or other substance 11 that is equal to, or approximately equal to, one of controlled doses. For example, if the dispensing apparatus was intended to provide three controlled doses, the tip 5 could include at least two dosage stops 28 separating the amount of the controlled doses. When the user compressed the compressible section 3 with a certain amount of force, the check valve 9 would extend into the tip 5 to push the fluid or other substance 11 only so much as would dispense one controlled dose through the opening at the tip 5 once the breakaway section 7 had been removed. The check valve 9 would then come to rest on the dosage stop. In order to dispense the second dose, the user would then have to compress the compressible region with an amount of force large enough to overcome the interference of the dosage stop and extend the check valve 9 further into the tip 5 to the next ring. The process would continue again in the same fashion to dispense the third controlled dose.

According to such aspects of the disclosure, as discussed above, the dispensing apparatus 1 may contain one or more of dosage stops 28 in the form of rings (e.g., similar to the retaining ring in size), or protrusions or other retaining devices on its interior wall of the tip 5. The dosage stops 28 may slightly protrude into the path of the check valve 9 when the check valve is being pushed down the tube 2. The dosage stops 28 would be flexible enough to deform in order to allow the check valve 9 to pass, but rigid enough so that when the check valve 9 moves past the rings (or protrusions or other retaining devices), the dosage stops 28 would snap back into place and emit a certain audible sound (e.g., a “click”). Therefore, upon hearing the audible sound, the user would know that the check valve 9 had moved to the next position and, therefore, it would be understood that a controlled dose had been dispensed. It is noted, that in some embodiments, a corresponding recess may be provided on the upper end of the check valve to receive the dosage stops 28 and thereby provide the audible indicator. Additionally, or alternatively, one or more dosage stops 28 in the form of interference rings (e.g., similar to the retaining ring in size) or protrusions of other retaining devices could be provided in order to allow the user to be able to feel the check valve 9 being moved to a particular position in the dispensing apparatus 1. For example, a certain pressure may be required to move check valve 9 past a dosage stop 28 and once the check valve 9 passed that dosage stop 28, the amount of resistance would subside and, hence, the user would know that the check valve 9 was in the empty position and, therefore, it would be understood that the controlled dose had been dispensed.

One example of an aspect of the disclosure involves an apparatus for dispensing a controlled dose. The apparatus includes a tube and a check valve (valve member), and the check valve includes a wiper ring. The tube in this example includes a compressible section (e.g. first portion), a tip (e.g. second portion), a breakaway section (e.g. third portion), and a retaining ring positioned on the interior of a wall of the tube.

As mentioned above, particular aspects of this disclosure may relate to dispensing apparatus 1 configured to be used as dispenser for a nasal spray. Particular substances that may be used in conjunction with such an embodiment of the disclosure may include: NASOBOL (Itra-nasal Testoserone), ANDRODERM, NOSEAFIX, Bepotastine, Civamide, Ereska, FluNsure, Intranasal Diazepam, Midazoam, Morphine Gluconate, Nasal LORAZEPAM, NASCOBAL, Pieconaril, Rylomine, and SinuNase.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An apparatus for dispensing a controlled dose of a substance, said apparatus comprising:
a first portion being compressible;
a second portion extending from said first portion, said second portion being sized to receive the substance;
a third portion being removably coupled to said second portion, said third portion revealing an aperture in said second portion upon removal of said third portion; and
a valve member slidably disposed in said second portion, said valve member being movable to urge the substance within said second portion out of said aperture.

2. The apparatus according to claim 1 wherein said valve member is a piston.

3. The apparatus according to claim 1, further comprising:
a wiper member extending about at least a circumferential portion of said valve member, said wiper member being sized to slidably engage an interior surface of said second portion.

4. The apparatus according to claim 1, further comprising:
a wiper member circumferentially extending about said valve member, said wiper member being sized to slidably engage an interior surface of said second portion.

5. The apparatus according to claim 1, further comprising:
a retaining member extending about at least a circumferential interior portion of said second portion, said retaining member being sized to engage and generally slidingly support said valve member.

6. The apparatus according to claim 1 wherein said valve member is slidably urged along said second portion in response to an increase pressure within said first portion.

7. The apparatus according to claim 1 wherein said valve member is slidably urged along said second portion in response to a compressive force from a user.

8. The apparatus according to claim 1 wherein said valve member comprises a tapered portion and is slidably urged along said second portion in response to a force exerted upon said tapered portion.

9. The apparatus according to claim 1 wherein said valve member is a sphere.

10. The apparatus according to claim 1 wherein said controlled dose is in the range of 0.2 to 0.6 milliliters.

11. The apparatus according to claim 1, further comprising:
a separation wall disposed within said second portion, said separation wall defining adjacent, fluidly-distinct volumes within said second portion.

12. The apparatus according to claim 11 wherein said separation wall is breakable to permit mixing of substance within said adjacent, fluidly-distinct volumes.

13. The apparatus according to claim 11 wherein said valve member is bifurcated to permit urging of substance within at least one of said adjacent, fluidly-distinct volumes out of said aperture.

14. The apparatus according to claim 1, further comprising:
at least one dosage stop disposed in said second portion, said dosage stop providing feedback to a user when said valve member has moved sufficiently to dispense a first controlled dose from said aperture, said at least one dosage stop being operable to permit further movement of said valve member sufficient to dispense a second controlled dose from said aperture.

15. The apparatus according to claim 1 wherein said third portion is integrally formed with said second portion and separable therefrom.

16. An apparatus for dispensing a controlled dose of a substance, said apparatus comprising:
a tube portion being compressible;
a tip portion extending from said tube portion, said tip portion being sized to receive the substance;
a breakaway portion being removably coupled to said tip portion, said breakaway portion revealing an aperture in said tip portion upon removal of said breakaway portion; and
a valve member slidably disposed in said tip portion, said valve member being movable to urge the substance within said tip portion out of said aperture.

17. The apparatus according to claim 16 wherein said tube portion is fluidly sealed such that upon compression of said tube portion, pressure therein is exerted upon said valve member to move said valve member.

18. The apparatus according to claim 16 wherein said tube portion is compressible to permit physical contact between said tube portion and said valve member to move said valve member.
